(19) United States
(12) Patent Application Publication
(10) Pub. No.: US 2013/0155273 A1
(43) Pub. Date: Jun. 20, 2013

(54) IMAGING APPARATUS AND CAPTURING METHOD

(71) Applicant: Samsung Electronics Co., Ltd., Gyeonggi-do (KR)

(72) Inventor: Yuki ENDO, Kanagawa (JP)

(73) Assignee: Samsung Electronics Co., Ltd., Gyeonggi-do (KR)

(21) Appl. No.: 13/716,872

(22) Filed: Dec. 17, 2012

(30) Foreign Application Priority Data
Dec. 16, 2011 (JP) 2011-276466

(51) Int. Cl. H04N 5/225

(52) U.S. Cl. CPC H04N 5/225
USPC 348/222.1

(57) ABSTRACT

A method and an apparatus for controlling image capturing according to an image value degree are provided. The imaging apparatus includes an imaging unit that captures an image; an image value degree calculator that calculates an image value degree indicating a value of an image captured by the imaging unit; and an image controller that controls capturing by the imaging unit depending on the image value degree calculated by the image value degree calculator.

### PRIORITY

This application claims priority under 35 U.S.C. §119(a) to Japanese Application Serial No. 2011-276466, which was filed in the Japanese Patent Office on Dec. 16, 2011, the entire content of which is hereby incorporated by reference.

### BACKGROUND OF THE INVENTION

1. Field of the Invention

The present invention relates generally to an imaging apparatus and a capturing method, and more particularly, to a method and an apparatus for capture control.

2. Description of the Related Art

Conventionally, there has been a technology for calculating a value indicating the value of an image (hereinafter, “image value degree”). For example, according to Japanese Patent Publication Laid-Open No. 2010-226278, an image value degree may be calculated from an image at the time of capturing the image, and the image value degree can be stored in a storage medium together with the image. According to this publication, at the time of reproducing an image, the convenience of the user who browses the image can be enhanced by performing a display according to the image value degree.

The image value degree calculated in this manner can be applied in various cases. For example, it can be expected to extract a portion of which the image value degree is high from the entire set of images as a summary moving picture. By reproducing the extracted summary moving picture, for example, the portion of which the image value degree is high from the entire set of images can be browsed by the user. However, in this publication, performing capture control based on the image value degree is not disclosed. That is, according to this publication, it is possible to edit images at the time of reproduction based on the image value degree, but capturing the image may not be controlled. Therefore, a method and apparatus for performing the capture control based on the image value degree is needed.

### SUMMARY OF THE INVENTION

In order to solve the problems described above, and to provide the advantages set forth below, an aspect of the present invention provides a method and an apparatus for controlling capturing based on the image value degree. In addition, the imaging apparatus according to the present invention includes an imaging unit that captures an image; an image value degree calculator that calculates an image value degree indicating a value of an image captured by the imaging unit; and an image controller that controls capturing by the imaging unit depending on the image value degree calculated by the image value degree calculator. In addition, the image value degree calculator according to the present invention calculates the image value degree by analyzing the image captured by the imaging unit.

According to another aspect of the present invention, a capturing method of an imaging apparatus includes capturing an image, calculating an image value degree indicating a value of the image and controlling the capturing of the image according to the image value degree

### BRIEF DESCRIPTION OF THE DRAWINGS

The above and other aspects, features, and advantages of the present invention will be more apparent from the following detailed description taken in conjunction with the accompanying drawings, in which:

FIG. 1 illustrates a configuration of an imaging apparatus according to an embodiment of the present invention;

FIG. 2 is a flowchart illustrating an operation process of the imaging apparatus according to an embodiment of the present invention;

FIGS. 3 and 4 illustrate calculation examples of image value degrees by an image analysis according to an embodiment of the present invention;

FIGS. 5, 6 and 7 illustrate examples for calculating the image value degree by a sound analysis according to an embodiment of the present invention;

FIGS. 8 and 9 illustrate creation examples of a summary moving image based on an image value degree according to an embodiment of the present invention;

FIG. 10 is a table indicating modes of the imaging apparatus according to an embodiment of the present invention;

FIG. 11 is a mode transition diagram illustrating mode transition of the imaging apparatus according to an embodiment of the present invention;

FIG. 12 is a table indicating examples of capture control in a moving image recording mode and an image view mode according to an embodiment of the present invention;

FIG. 13 is a table indicating examples of capture control in a capture standby mode according to an embodiment of the present invention;

FIG. 14 is a table indicating examples of the capture control according to another embodiment of the present invention;

FIGS. 15 to 18 are diagrams illustrating the capture results according to the prior art; and

FIGS. 19 to 22 are diagrams illustrating the capture results by the imaging apparatus according to an embodiment of the present invention.

### DETAILED DESCRIPTION OF EMBODIMENTS OF THE PRESENT INVENTION

Hereinafter, with reference to the accompanying drawings, embodiments of the present invention are described in detail. In the specification and drawings, components with the substantially the same functions are denoted by the same reference numerals, and a repetitive description will not be provided.

The imaging apparatus according to the present invention includes an imaging unit that captures an image, an image value degree calculator that calculates an image value degree indicating the value of an image captured by the imaging unit, and an image controller that controls the capturing of the imaging unit depending on the image value degree calculated by the image value degree calculator. The capturing of the imaging unit is controlled according to the image value degree calculated by the image value degree calculator.

The imaging apparatus controls the capturing by various techniques depending on the image value degree. The image value degree calculator calculates an image value degree by using a result obtained by analyzing an image captured by the imaging unit. In this manner, in order to calculate the image value degree, the image itself is analyzed, so it is possible to calculate an image value degree that matches with the image.

The image value degree calculator also calculates an image value degree based on an existing position of an object in the image. Accordingly, since it is expected that the user who browses the image pays attention to an object which appears on the image, an image value degree is calculated in consideration of an existing position of the object to which attention is paid. For example, the importance degree of the image may be calculated to be higher as the existing position of the object is closer to the center.

The image value degree calculator further calculates an image value degree according to the movement amount of the object in the image. According to the configuration, since it is expected that the user who browses the image pays attention to the object which appears on the image, the image value degree is calculated in consideration of the movement amount of the object to which the user may pay attention. For example, as the movement amount of the object is smaller, the importance of the image is calculated to be higher.

The imaging apparatus further includes a sound input unit that receives sound input, and the image value degree calculator also calculates the image value degree according to the result obtained by analyzing the sound input by the sound input unit. Accordingly, since the sound may be interpreted in order to calculate the image value degree, the sound-considered image value degree is calculated.

The imaging apparatus further includes a detector that detects information indicating the movement of the image apparatus as sensor information, and the image value degree calculator then calculates the image value degree according to the result obtained by analyzing the sensor information detected by the detector. Accordingly, in order to calculate the image value degree, the sensor information is interpreted, so the sensor information-considered image value degree is calculated.

The imaging apparatus further includes a display control unit that controls a display unit so that the control result of the image controller is displayed on the display unit. Accordingly, since the display unit is controlled so that the control result of the image controller is displayed on the display unit, the user is notified how the capturing is controlled.

In addition, another embodiment of the present invention provides an imaging method including capturing an image, calculating an image value degree that indicates a value of the image, and controlling the capturing of the image.

According to these methods, the capturing is controlled based on the calculated image value degree. The capturing is controlled by various techniques based on the image value degree.

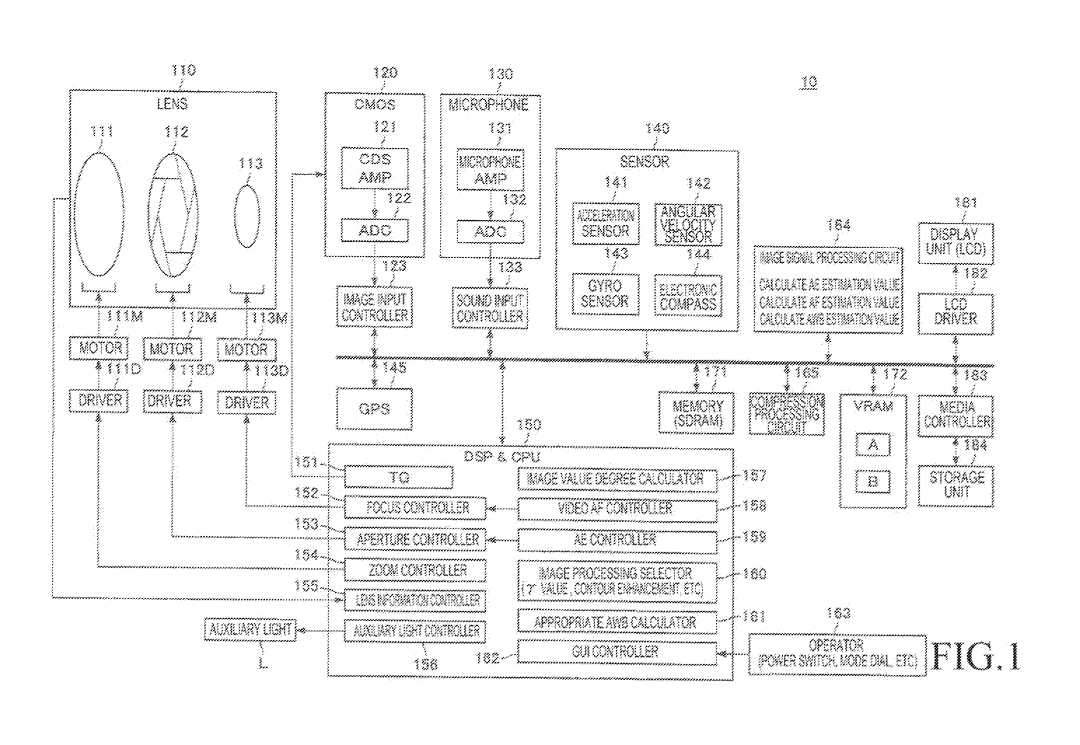

FIG. 1 illustrates a configuration of the imaging apparatus 10 according to an embodiment of the present invention. As illustrated in FIG. 1, an imaging apparatus 10 includes a lens 110, a CMOS (Complementary Metal Oxide Semiconductor) 120, an image input controller 123, a microphone 130, a sound input controller 133, a sensor 140, a GPS (Global Positioning System) 145, and a DSP (Digital Signal Processor) and a CPU (Central Processing Unit) 150.

In addition, the imaging apparatus 10 includes an operator 163, an image signal processing circuit 164, a compression processing circuit 165, a memory (Synchronous Dynamic Random Access Memory: SDRAM) 171, a VRAM (Video RAM) 172, a display unit (for example, a Liquid Crystal Display (LCD)) 181, an LCD driver 182, a media controller 183, and a storage unit 184. In addition, the imaging apparatus 10 includes motors 111M, 112M, and 113M, and drivers 111D, 112D, and 113D.

The lens 110 includes a zoom lens 111, an aperture 112, and a focus lens 113, and is an optical system in which an image is formed on the CMOS 120 by passing light from an object. The zoom lens 111 is a lens that changes an angle of view by changing a focal length. The aperture 112 is an apparatus that adjusts the amount of light (light amount). The focus lens 113 focuses on an object image on a capturing surface of the CMOS 120 by moving in a direction from one side to another or in a reverse direction thereof.

The CMOS 120 is a photoelectric conversion element, and is configured by a plurality of elements that can perform photoelectric conversion for converting incident light information through the lens 110 into an electric signal. Further, the CMOS 120 is only an example of an imaging element, and for example, a CCD (Charge Coupled Device) or the like may be used instead of the CMOS 120. The CMOS 120 can be used as an example of an imaging unit.

In addition, in order to control an exposure time of the CMOS 120, a mechanical shutter (not illustrated) or an electronic shutter (not illustrated) can be applied. In addition, the operation of the mechanical shutter or the electronic shutter is performed by a switch of the operator 163 connected to the DSP and CPU 150. The CMOS 120 may include a CDS AMP (AMPlifier) 121, and an ADC (Analog to Digital Converter) 122.

The CDS AMP (Correlated Double Sampling Circuit/Amplifer) 121 eliminates a low-frequency noise included in the electric signal after conversion from the light information by the CMOS 120 and amplifies the electric signal to a certain level.

The ADC 122 generates a digital signal by performing digital conversion on the electric signal output from the CDS AMP 121. The ADC 122 outputs the generated digital signal to the image input controller 123.

The image input controller 123 processes the digital signal input from the ADC 122, generates an image signal that enables an image process, and outputs the generated image signal, for example, to an image signal processing circuit 164. In addition, the image input controller 123 controls the access of the image data to the memory (SDRAM) 171.

The microphone 130 converts the vibration of an acoustic wave into an electric signal. The microphone 130 includes a microphone AMP 131, and an ADC 132. The microphone AMP 131 eliminates the low-frequency noise included in the electric signal converted from sound information by the microphone 130 and amplifies the electric signal to a certain level. The microphone 130 functions as a sound input unit that receives sound input.

The ADC 132 performs digital conversion on the electric signal output from the microphone AMP 131 and generates a digital signal. The ADC 132 outputs the generated digital signal into the sound input controller 133. The sound input controller 133 controls the access of the digital signal input from the ADC 132 to the SDRAM 171.

The sensor 140 functions as a detector that detects information indicating the movement of the imaging apparatus 10 as sensor information. The sensor information detected by the sensor 140 can be used for calculating the image value degree by an image value degree calculator 157, which is part of the DSP and CPU 150. The sensor 140 may include, for example, an acceleration sensor 141, an angular velocity sensor 142, a gyro sensor 143, and an electronic compass 144.

The VRAM 172 is a memory for displaying an image, and includes a plurality of channels (a channel A and a channel B illustrated in FIG. 1). The VRAM 172 performs an input of image data for an image display from the SDRAM 171 and an output of image data to the LCD driver 182. A resolution and a maximum number of colors of the display unit (LCD) 181 depend on a capacity of the VRAM 172.

The SDRAM 171 is an example of a storage apparatus, and temporarily stores the image data of the captured image. The SDRAM 171 includes a storage capacity for storing a plurality of items of image data, sequentially maintains the image signal at the time of focus control, and outputs an image signal. In addition, the SDRAM 171 stores an operation program of the DSP and CPU 150. The reading of the image data from the SDRAM 171 and the storing of the image data to the SDRAM 171 is controlled by the image input controller 123.

The LCD driver 182 is a display driving unit, for example, that receives image data from the VRAM 172 and enables the LCD 181 to display the image.

The LCD 181 is an example of the display unit mounted on a main unit of the imaging apparatus 10, and displays, for example, an image before capturing read from the VRAM 172 (live view display), various setting screens, captured and stored images, or the like. According to the present embodiment, the LCD functions as a display unit, and the LCD driver 182 functions as a display driving unit of the display unit, but the present invention is not limited thereto. For example, an organic EL (Organic Electro-Luminescence) display may function as a display unit, and an organic EL display driving unit may function as a display driving unit.

The media controller 183 controls the storage of the image data to the storage unit 184, or the reading of the image data, the setting information, or the like stored in the storage unit 184.

The storage unit 184 is, for example, an optical disc (a CD, a DVD, a Blu-ray disc, or the like), a magnetic optical disc, a magnetic disc, a semiconductor storage medium, or the like, and stores captured image data. Here, the media controller 183 and the storage unit 184 can be configured to be detachable from the imaging apparatus 10.

The compression processing circuit 165 receives an image signal before compression processing, and performs compression processing on the image signal into a compression format such as JPEG, for example. The compression processing circuit 165 sends the image data generated by the compression processing to, for example, the media controller 183.

The image signal processing circuit 164 receives an image signal from the image input controller 123, performs various kinds of image processing on the image signal based on a white balance control value, a y value, a contour enhancement control value, or the like, and generates an image signal after image processing. In addition, the image signal processing circuit 164 relating to the present embodiment calculates an AE (Auto Exposure) evaluation value using the image signal, and transmits the calculated AE evaluation value to the DSP and CPU 150. In the same manner, the image signal processing circuit 164 calculates the AF (Auto Focus) evaluation value based on the image signal, and transmits the calculated AF (Auto Focuses) evaluation value to the DSP and CPU 150. In addition, the image signal processing circuit 164 calculates an AWB (Auto White Balance) evaluation value and transmits the calculated AWB (Auto White Balance) evaluation value to the DSP and CPU 150.

The operator 163 may be, for example, arrow keys, a power switch, a mode dial, a shutter button or the like arranged on the imaging apparatus 10, and transmits an operation signal according to the operation by the user to the DSP and CPU 150. For example, the shutter button can be half-pressed, fully-pressed, or released by the user. The shutter button outputs an operation signal for starting focus control at the time of being half-pressed, and outputs an operation signal for ending focus control at the time of being released from the half-press. In addition, the shutter button outputs an operation signal for starting capturing at the time of being fully-pressed.

The DSP and CPU 150 operates as an arithmetic processing unit and a controller, and controls processing of each component arranged in the imaging apparatus 10. The DSP and CPU 150 outputs signals to the drivers 111D, 112D, and 113D according to focus control or an exposure control, for example. In addition, according to an operation signal from the operator 163, each component of the imaging apparatus 10 is controlled. In addition, according to the present embodiment, the DSP and CPU 150 is one unit, but may include a plurality of CPUs so that an operation relating to a signal system and an operation relating to an operation system are performed on respective CPUs, or may include a DSP and a CPU in a separated manner. The DSP and CPU 150 according to the present invention may include each function unit as illustrated in FIG. 1.

The image value degree calculator 157 calculates an image value degree indicating the value of the image captured by the CMOS 120. The image used for an image value degree calculation may be an image signal which is sequentially output from the image input controller 123, or may be an image signal after image processing which is sequentially output from the image signal processing circuit 164. The image value degree calculation will be described below.

When an operation signal for starting focus control is received, a video AF controller 158 generates a control signal for moving a focus lens 113 in a direction and outputs the generated control signal to a focus controller 152. In addition, the video AF controller 158 calculates a focusing position of the focus lens 113 based on an AF evaluation value calculated by the image signal processing circuit 164, and outputs the calculated focusing position as a control signal to the focus controller 152.

The AF evaluation value is a contrast value of an image, for example. When the contrast value reaches its peak, the video AF controller 158 determines that the object image is focused on the capturing surface of the CMOS 120 (contrast detection method). In addition, the video AF controller 158 determines at least one main object according to the distance with the object image.

When an operation signal for starting an aperture control is received, an AE controller 159 generates a control signal for adjusting the aperture 112, and outputs the generated control signal to an aperture controller 153. In addition, the AE controller 159 calculates the aperture value based on the AE evaluation value calculated by the image signal processing circuit 164, and outputs the aperture value as a control signal to the aperture controller 153.

When an operation signal for starting to select image processing is received, an image processing selector 160 selects image processing by the image signal processing circuit 164 according to the operation signal. The image processing by the image signal processing circuit 164 is not particularly limited, but the image processing by the image signal processing circuit 164 can be white balance correction, γ correction, contour enhancement, or the like, for example.

An appropriate AWB calculator 161 calculates appropriate AWB based on an image value degree calculated by an image value degree calculator 157. The AWB calculated by the appropriate AWB calculator 161 is provided for the white balance correction by the image signal processing circuit 164. In other words, the focus controller 152 may operate as an image controller that controls capturing by an imaging unit based on the image value degree calculated by the image value degree calculator 157.

A GUI (Graphical User Interface) controller 162 manages a screen displayed by the LCD 181. For example, the GUI controller 162 outputs a control signal for displaying a screen selected by an operation signal output from the operator 163 on the LCD 181 to the LCD driver 182. In addition, the GUI controller 162 may function as a display control unit that outputs the result of the capture control described below on the LCD 181 to the LCD driver 182.

A TG (Timing Generator) 151 outputs a timing signal to the CMOS 120, and controls an exposure time of each pixel included in the CMOS 120 or the reading of a charge of each pixel included in the CMOS 120.

When an operation signal for starting focus control is received, the focus controller 152 generates a control signal for adjusting the focus lens 113 to the driver 113D. In addition, the focus controller 152 generates a control signal for adjusting the focus lens 113 based on the image value degree calculated by the image value degree calculator 157, and outputs the generated control signal to the driver 113D. That is, the focus controller 152 functions as an example of an image controller that controls the capturing of the imaging unit according to the image value degree calculated by the image value degree calculator 157.

When an operation signal for starting an aperture control is received, the aperture controller 153 generates a control signal for adjusting the aperture 112 and outputs the generated control signal to the driver 112D. In addition, the aperture controller 153 generates a control signal for adjusting the aperture 112 according to the image value degree calculated by the image value degree calculator 157, and outputs the control signal to the driver 112D. That is, the aperture controller 153 functions as an example of an image controller that controls the capturing by the imaging unit according to the image value degree calculated by the image value degree calculator 157, for example.

When an operation signal for starting a zoom control is received, a zoom controller 154 generates a control signal for adjusting the zoom lens 111 and outputs the generated control signal to the driver 111D. In addition, the zoom controller 154 generates a control signal for adjusting the zoom lens 111 based on the image value degree calculated by the image value degree calculator 157 and outputs the generated control signal to the driver 111D. That is, the zoom controller 154 functions as an example of the image controller that controls the capturing by the imaging unit based on the image value degree calculated by the image value degree calculator 157, for example.

A lens information controller 155 may obtain the result (lens information) of the capture control from the lens 110. For example, the lens information controller 155 may obtain the result of the capture control by the focus controller 152 (the value of the focus lens 113), the result of the capture control by the aperture controller 153 (the value of the aperture 112), the result of the capture control by the zoom controller 154 (the value of the zoom lens 111), or the like, as a result of the capture control.

An auxiliary light controller 156 controls auxiliary light L that is generated by an auxiliary light emitting device. When an operation signal for starting an auxiliary light control is received, the auxiliary light controller 156 generates a control signal for adjusting the auxiliary light L and outputs the generated control signal to the auxiliary light emitting device. For example, the auxiliary light controller 156 generates a control signal for adjusting an auxiliary light based on the image value degree calculated by the image value degree calculator 157 and outputs the generated control signal to the auxiliary light emitting device. That is, the auxiliary light controller 156 functions as an example of an image controller that controls the capturing by the imaging unit based on the image value degree calculated by the image value degree calculator 157, for example.

The GPS (Global Positioning System) 145 estimates a location of the imaging apparatus 10 based on a satellite signal received from a GPS satellite. The location of the imaging apparatus 10 estimated by the GPS 145 may be used for calculation of an image value degree by the image value degree calculator 157

The driver 111D generates a driving signal according to the control signal received by the zoom controller 154, and transmits the generated driving signal to the motor 111M to drive the motor 111M. As a result, the motor 111M controls the zoom lens 111.

The driver 112D generates a driving signal based on the control signal generated by the aperture controller 153, and transmits the generated driving signal to the motor 112M to drive the motor 112M. As a result, the motor 112M controls the aperture 112.

The driver 113D generates a driving signal based on a control signal received from the focus controller 152, and transmits the generated driving signal to the motor 113M to drive the motor 113M. As a result, the motor 113M controls the focus lens 113.

It is to be understood that a series of processes in the imaging apparatus 10 may be performed by a hardware, or may be software processes performed by a program on a computer, or may be performed by a combination of hardware and software.

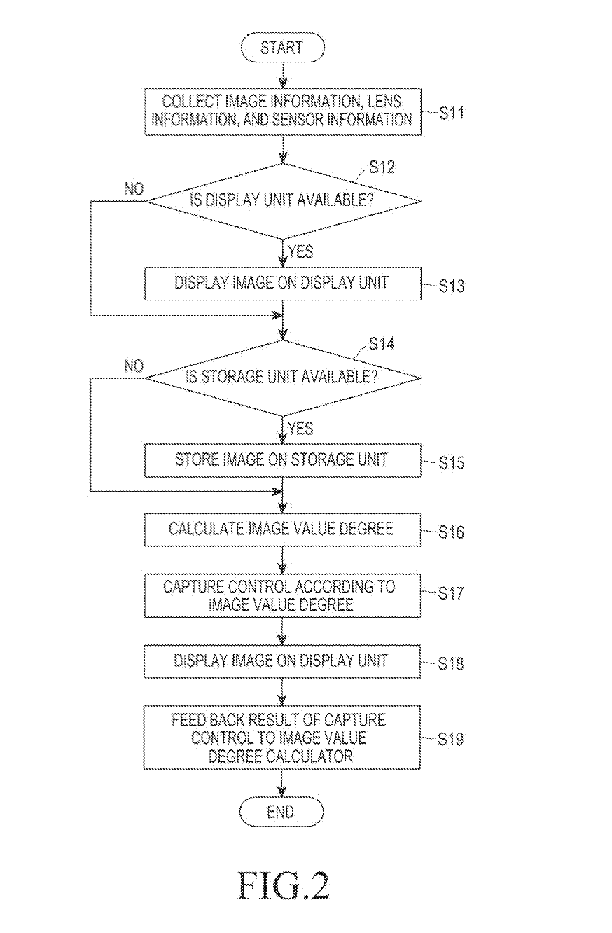

Next, the operation of the imaging apparatus 10 relating to the embodiment of the present invention will be described with reference to the flowchart of FIG. 2.

As illustrated in FIG. 2, the DSP and CPU 150 collects image information, lens information, and sensor information in Step S11. The DSP and CPU 150 determines whether the LCD display unit 181 is available in Step S12, and if the LCD display unit 181 is not available in Step S12, the process proceeds to Step S14. However, if the LCD display unit 181 is available in Step S 12, the GUI controller 162 performs control so that the image is displayed on the LCD 181 in Step S13, and the process then proceeds to Step S14.

The DSP and CPU 150 determines whether the storage unit 184 is available in Step S14, and if the storage unit 184 is unavailable in Step S14, the process proceeds to Step S16. If the storage unit 184 is available in Step S14, the DSP and CPU 150 performs control so that the image is stored on the storage unit 184 in Step S15, and the process proceeds to Step S16.

Next, the image value degree calculator 157 calculates an image value degree based on the image signal in Step S16. The image controller controls capturing based on the image value degree calculated by the image value degree calculator 157 in Step S17. An example of the image controller may be the focus controller 152, the aperture controller 153, the zoom controller 154, the auxiliary light controller 156, and the appropriate AWB calculator 161.

Next, the GUI controller 162 displays the image on LCD 181 in Step S18. The image displayed at this point is an image captured after the capture control by the image controller. The result of the capture control may be obtained by a lens information controller 155, and is fed back to the image value degree calculator 157 in Step S19.

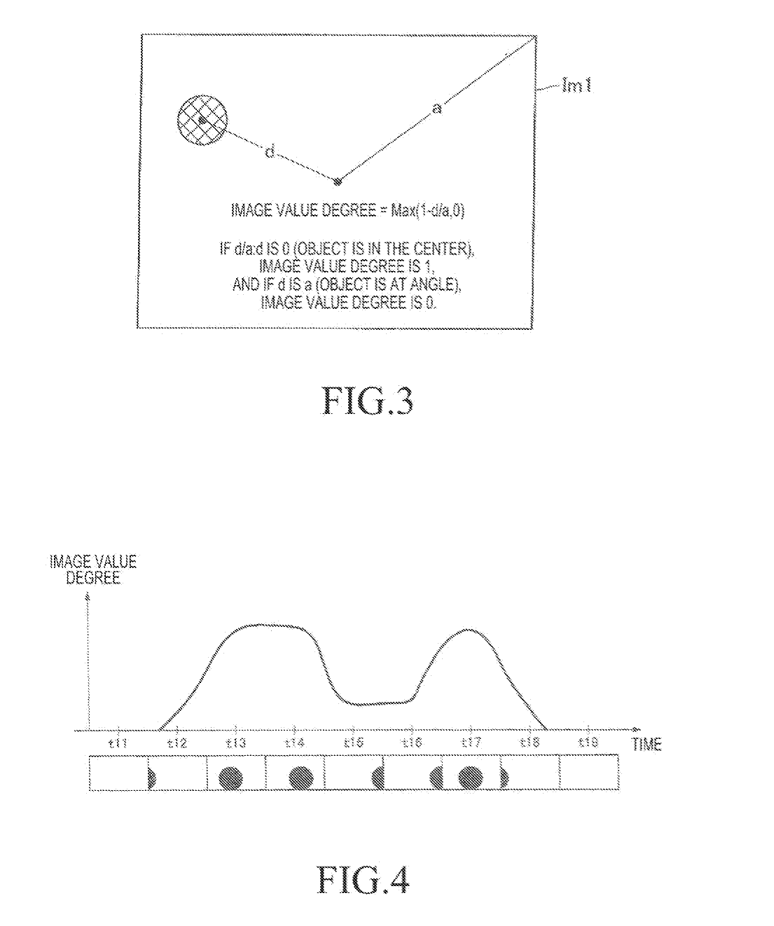

The calculation example of the image value degree by the image value degree calculator 157 will now be described, but first, a calculation example of the image value degree by the image analysis is described. FIGS. 3 and 4 illustrate calculation examples of image value degrees by an image analysis.

For example, the image value degree calculator 157 may calculate an image value degree by analyzing an image captured by the imaging unit. According to an example, an image value degree may be calculated based on the existing position of an object in an image. For example, if a captured image Im1 is captured as illustrated in FIG. 3, the image value degree calculator 157 calculates an image value degree to be higher as the object is closer to the center of the captured image Im1.

The temporal change of the captured images and the image value degrees where an image value degree is calculated based on the existing position of an object in an image is illustrated in FIG. 4. In this example, images in which a ball as an object rolls from the left of the screen, stops in the center, rolls to the right, stops at a position where the ball is half-hidden, and rolls back to the left to disappear from the screen are captured. In addition, according to the images, the upper portion of FIG. 4 illustrates image value degrees, and the lower portion of FIG. 4 illustrates an image group in which images at certain frames are sampled and arranged. As illustrated in FIG. 4, an image value degree is calculated to be higher as the ball is closer to the center of an image.

Further, the calculation method of the image value degree by an image analysis is not limited to the method described above. For example, the image value degree calculator 157 may calculate the image value degree according to a movement amount of the object in an image. In such a case, the image value degree calculator 157 calculates an image value degree to be higher, as the movement amount of an object become smaller in an image, for example. Otherwise, the image value degree calculator 157 may perform a calculation, so that the smaller the movement amount of the entire image is, the higher the image value degree is.

The calculation of the image value degree is not limited to a case of the image calculation. For example, the image value degree may be calculated by sound analysis. The calculation example of the image value degree by sound analysis is described below. FIGS. 5, 6 and 7 illustrate examples for calculating the image value degree by a sound analysis.

For example, the image value degree calculator 157 may calculate the image value degree by analyzing a sound input by the microphone 130. As an example, the image value degree calculator 157 may calculate the image value degree based on the volume of the sound. For example, when the loudness of a sound changes as illustrated in the upper portion of FIG. 5, the image value degree may be calculated as a value proportional to the loudness of the sound as illustrated in the lower portion of FIG. 5. For example, if an image is captured in a still site such as a concert hall, it is generally accepted that there are few sounds other than a musical performance. Therefore, it is appropriate to calculate an image value degree based on the loudness of a sound.

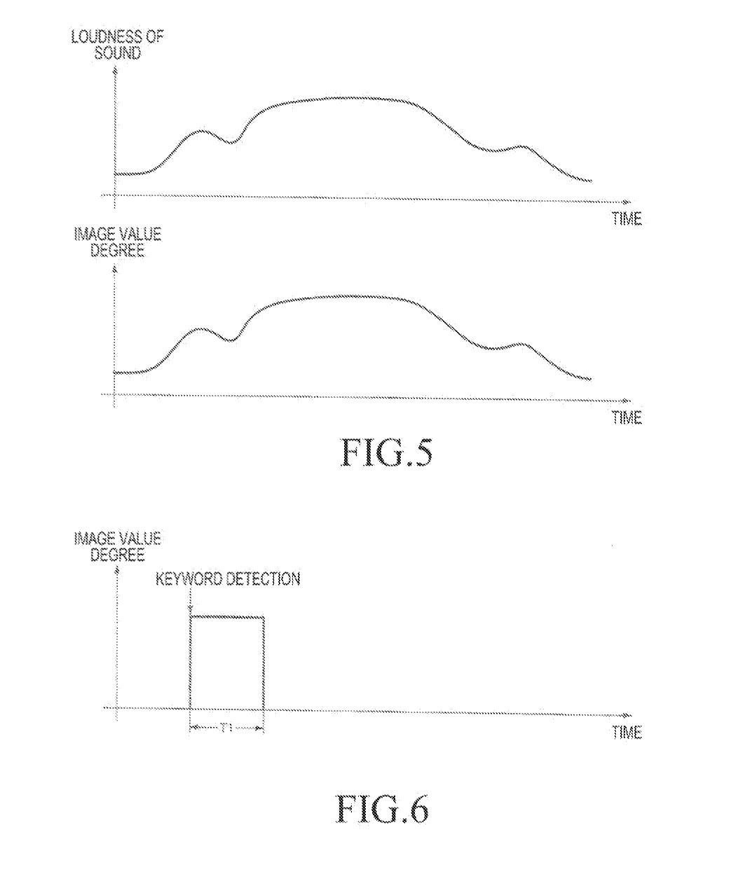

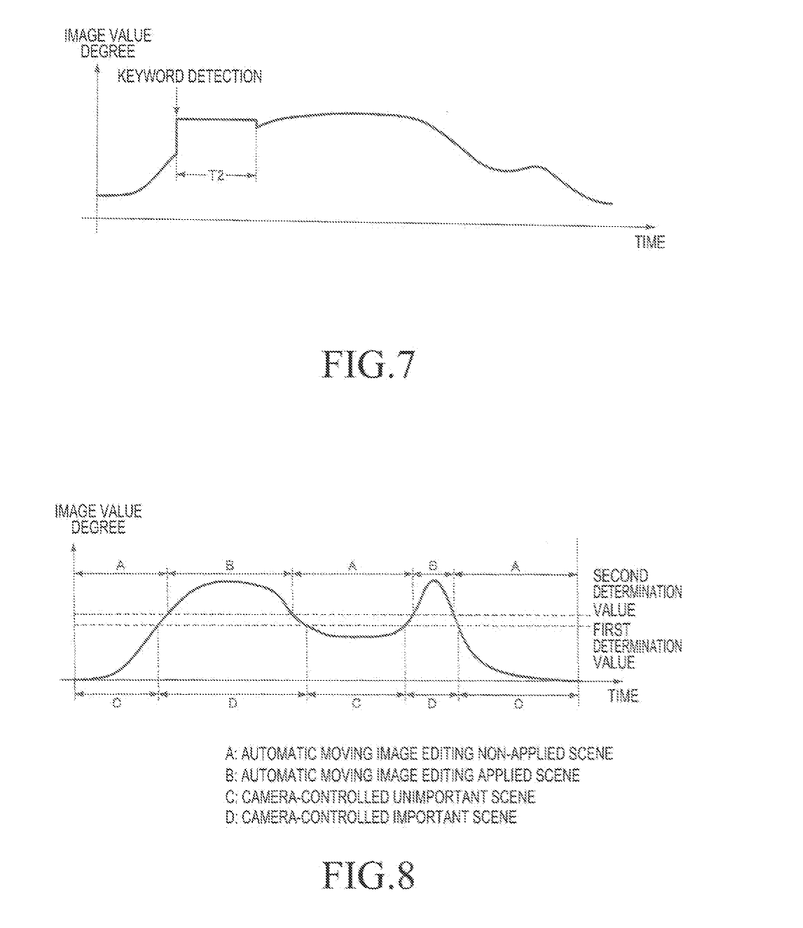

In addition, according to another example, the image value degree calculator 157 performs a calculation so that the image value degree becomes high when a certain keyword is detected from a sound. For example, as illustrated in FIG. 6, if a certain keyword is detected from a sound, the image value degree can be high for a certain period of time T1 after the keyword is detected. Or, as illustrated in FIG. 7, if a certain keyword is detected from the sound, the image value degree becomes high for a certain period of time T2 after the keyword is detected and the image value degree becomes a value proportional to the loudness of the sound for the other period of time.

The calculation of the image value degree by the sound analysis has been described above, but is not limited to cases involving an image analysis or a sound analysis. For example, if the information indicating the movement of the imaging apparatus 10 is detected as sensor information, the image value degree may be calculated by an interpretation of the sensor information. The sensor information is detected by the sensor 140, and the sensor information can be at least one of an acceleration detected by the acceleration sensor 141, an angular velocity detected by the angular velocity sensor 142, an angular velocity detected by the gyro sensor 143, and a direction detected by the electronic compass 144, for example.

If the information indicating movement of the imaging apparatus 10 is detected as sensor information, the image value degree calculator 157 calculates the image value degree to be higher, as the detected movement of the imaging apparatus 10 becomes smaller, for example, since it can be expected that the smaller the movement of the imaging apparatus 10, the more stable the captured image is. For example, the image value degree calculator 157 calculates an image value degree to be higher, as the change of the acceleration is smaller, calculates an image value degree to be higher as the change of the angular velocity is smaller, or calculates an image value degree to be higher as the change of the direction becomes smaller.

In addition, if the lens information is acquired by the lens information controller 155, for example, an image value degree may be calculated by an interpretation of the lens information. For example, in a case where the lens information indicates that the zoom lens 111 is manually operated faster than a certain threshold value, the image value degree calculator 157 may calculate the image value degree to be smaller than in other cases. Otherwise, in a case where the lens information indicates that a focus lens 113 is manually operated faster than a certain threshold value, the image value degree calculator 157 may calculate an image value degree to be lower than in the other cases.

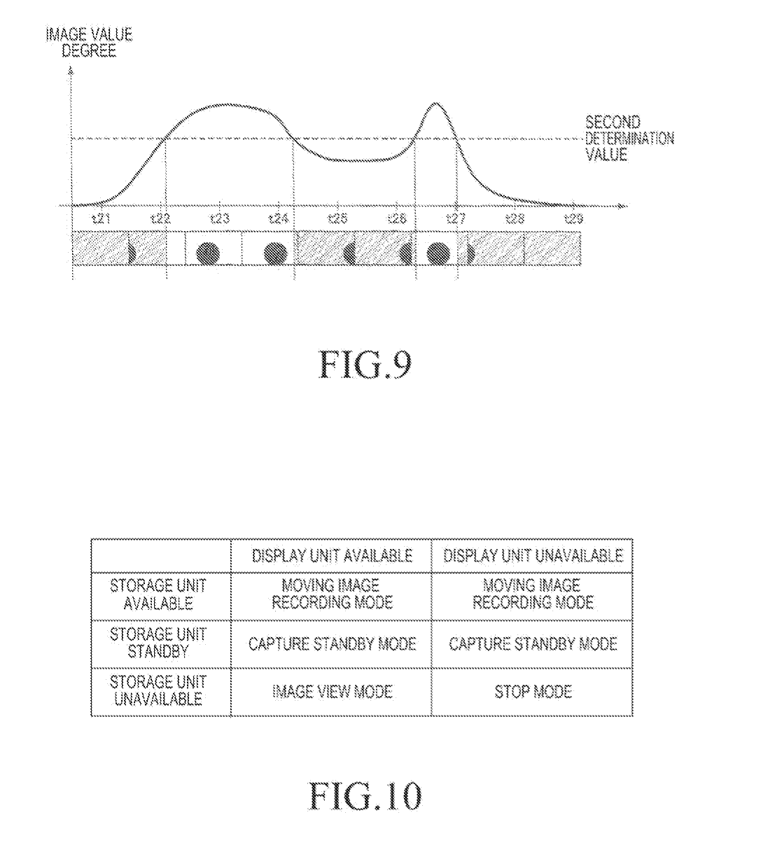

The calculation example of the image value degree can be used in various cases. For example, the image value degree can be used for creating a summary moving image. Creation examples of the summary moving image based on an image value degree is described below with reference to FIGS. 8 and 9.

For example, as illustrated in FIG. 8, a first determination value and a second determination value larger than the first determination value are set, a border between “C: a camera-controlled unimportant scene” and “D: a camera-controlled important scene” is set to be “an image value degree =a first determination value”, and a border between “A: an automatic moving image editing non-applied scene” and “B: an automatic moving image editing applied scene” is set to be “an image value degree=a second determination value”. By performing the settings as described above, a transition to an important scene in camera control is performed before an important scene on the image comes so that a delay in the camera control can be prevented. For example, when an image value degree and an image are changed as illustrated in FIG. 9, a summary moving image is created by clipping a portion in which the image value degree is higher than a second determination value.

The creation example of the summary image based on the image value degree has been described above. The image value degree is used in various scenes in addition to the creation of the summary moving image. For example, the image value degree may be used for the capture control. The example of the capture control based on the image value degree is explained below. In addition, the expression “an image value degree is high” or “an image value degree is low” refers to “an image value degree is higher than a threshold value” or “an image value degree is lower than a threshold value”. In addition, the tables presented below indicate how differently capturing an image is controlled by comparing a case when “an image value degree is high” or a case when “an image value degree is low”.

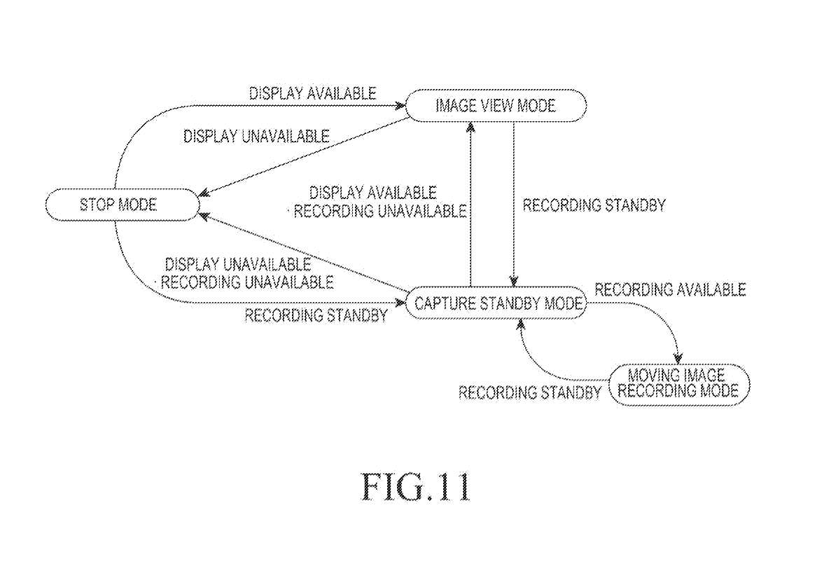

First, for example, when a home video is captured by the imaging apparatus 10, capture control is changed according to a mode of the imaging apparatus 10. FIG. 10 is a table indicating modes of the imaging apparatus 10, and FIG. 11 is a mode transition diagram illustrating mode transition of the imaging apparatus 10. A mode of the imaging apparatus 10 includes “a moving image recording mode”, “an image view mode”, “a capture standby mode”, “a stop mode”, and the like as illustrated in FIG. 10. In addition, the mode of the imaging apparatus 10 may be transitioned as illustrated in FIG. 11, for example.

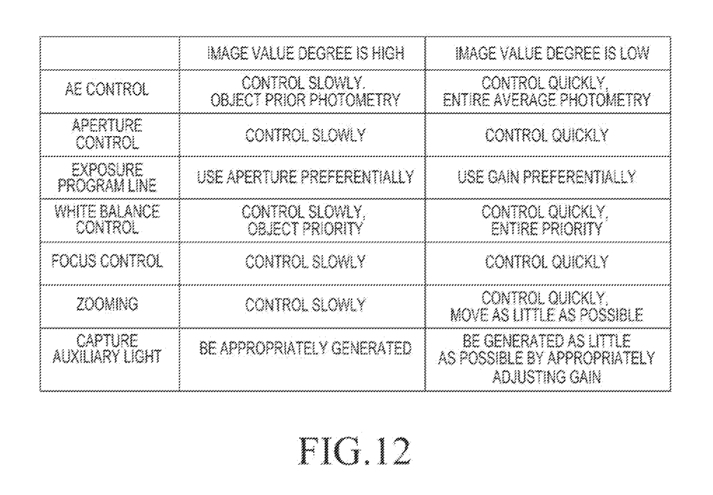

FIG. 12 is a table indicating examples of capture control in a moving image recording mode and an image view mode. In the moving image recording mode and an image view mode, the capture control is performed based on an image value degree as illustrated in FIG. 12. For example, when the image value degree is high as illustrated in FIG. 12, the capture control is performed so that an image can be easily viewed. In addition, if the image value degree is low, capture control for capture preparation in preparation for a case in which the image value degree is high or capture control relating to power saving is performed.

For example, if an image value degree is low, the “focus control” is performed “quickly”. According to the capture control, if the image value degree is low, the entire image is scanned, and a focus can be searched in preparation for a case in which the image value degree becomes high. In addition, for example, if the image value degree is high, a noise level of the image can be reduced by performing capture control in which a “capture auxiliary light” is “appropriately generated”. In addition, for example, by performing capture control in which a “capture auxiliary light” is “generated as little as possible by appropriately adjusting gain” when the image value degree is low, it is possible to make an image bright while saving power even though the noise level of the image becomes high.

When the result of the capture control is fed back to the image value degree calculator 157, the image value degree calculator 157 may calculate the image value degree so that the capture control is performed while giving weight to the fed-back value. For example, when an image value degree in which the capture control is transitioned is fed back, the image value degree calculator 157 may calculate the image value degree in which the effect of the transition on the image value degree is deducted. For example, when it is fed back that the capture control in which the “capture auxiliary light” is “generated as little as possible by appropriately adjusting gain” is transitioned to the capture control in which the “capture auxiliary light” is “appropriately generated”, the image value degree calculator 157 may calculate the image value degree in which the effect on the image value degree is deducted by generating the “capture auxiliary light”.

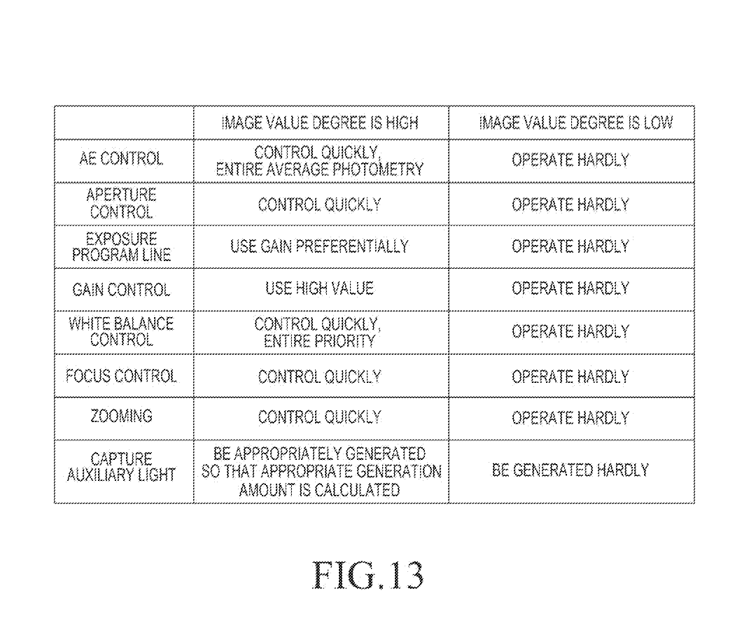

FIG. 13 is a table indicating examples of capture control in a capture standby mode. In the capture standby mode, capture control is performed based on the image value degree as illustrated in FIG. 13. For example, if the image value degree is high as illustrated in FIG. 13, the capture control is performed for capture preparation in preparation for a case in which capturing is available. In addition, for example, if the image value degree is low as illustrated in FIG. 13, the capture control is performed relating to power saving and the capture control is performed to a degree in which an image value degree is calculated. In addition, in a “stop mode”, no particular capture control is performed.

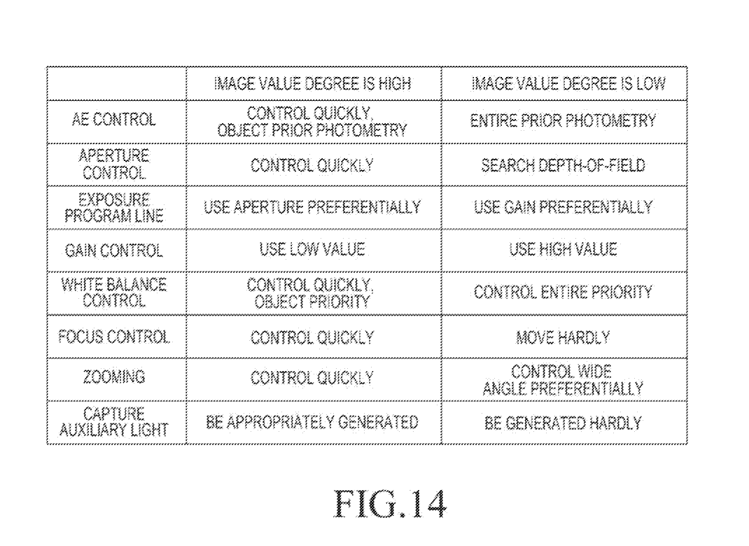

Subsequently, for example, when the imaging apparatus 10 is used as a monitoring camera, it may be assumed that the capture control is performed regardless of the mode of the imaging apparatus 10. FIG. 14 is a diagram indicating additional examples of the capture control. When the imaging apparatus 10 is used as a monitoring camera, the capture control is performed based on the image value degree as illustrated in FIG. 14. When the imaging apparatus 10 is used as a monitoring camera, it is required that each of the frames are high definition frames and it is rarely required that the moving image is easily viewed. Therefore, if the image value degree is high, a targeted object is focused on and control is performed so that the capture mode quickly becomes satisfactory. In addition, if the image value degree is low, control is performed so that the entire image is clearly captured.

The capture control based on the value degree has been described above. In this manner, a case in which the capture control is performed based on the image value degree has various effects compared with a case in which capture is performed by imaging apparatuses in the prior art. The effect of a case in which the capture control is performed based on the image value degree will be described below.

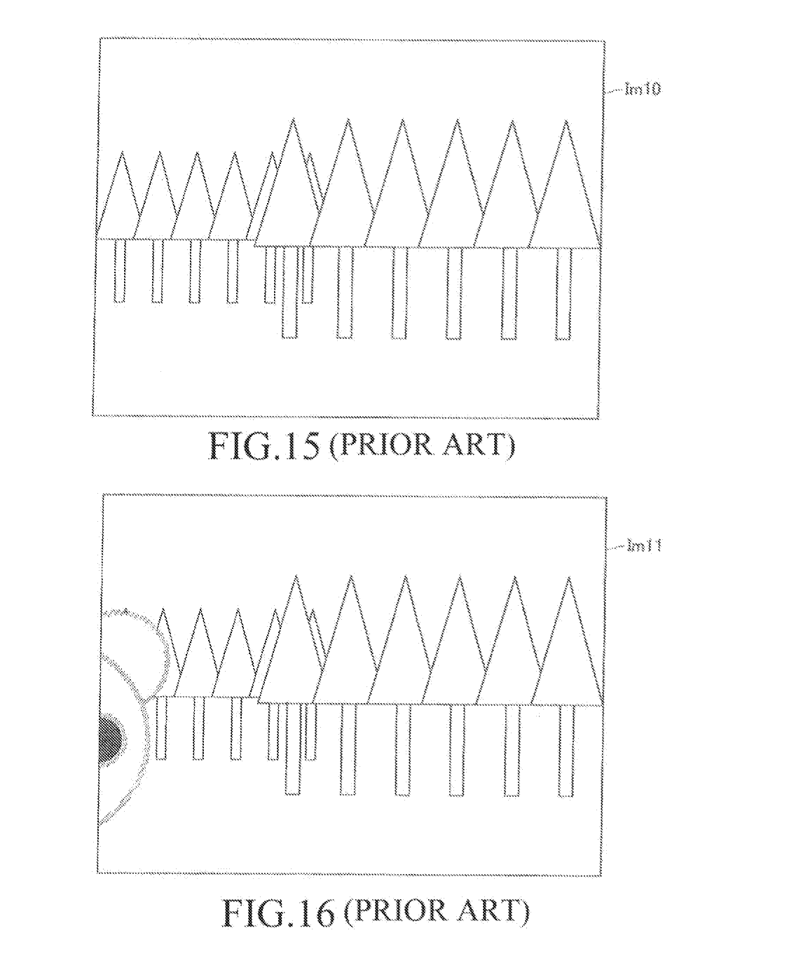

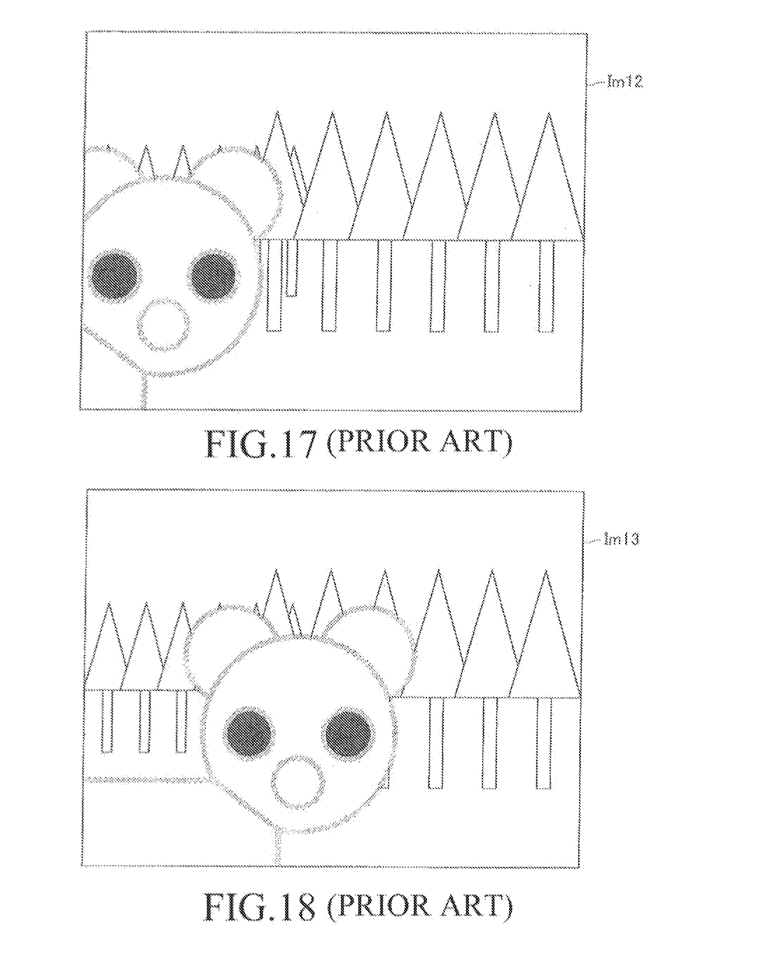

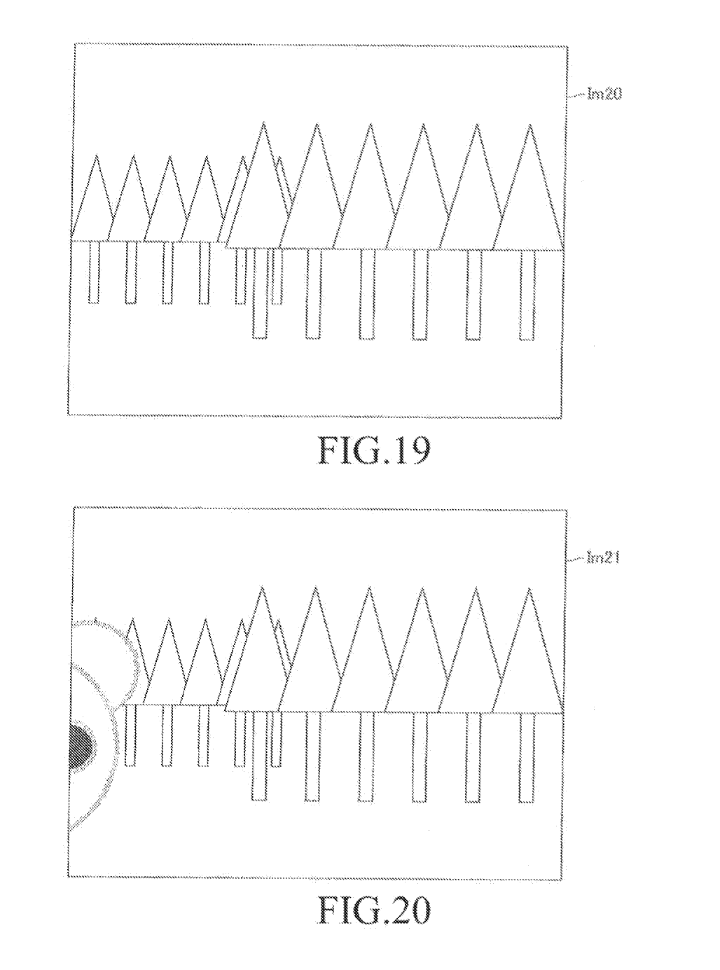

For example, as described above, by finding out a focus position when the image value degree is low, a focus can be quickly adjusted when the image value degree becomes high. Therefore, by performing the capture control based on the image value degree, the high definition moving image can be captured in an important scene. The effect is described with reference to the drawings. FIGS. 15 to 18 are diagrams illustrating the capture results by imaging apparatuses in the prior art, and FIGS. 19 to 22 are diagrams illustrating the capture results by the imaging apparatus 10 according to the embodiment of the present invention.

As illustrated in FIGS. 15 to 18, it is assumed that in a case of using a prior art technology, the image changes in a sequence of captured images Im10, Im11, Im12, and Im13. In a general movie AF, since if a focus is excessively shaken, it becomes difficult to bear watching the moving image, the stability is considered to be important so the focus is prevented from moving as much as possible.

In addition, in case of a contrast AF, since only the focus state in the current focus position can be known, it takes time to adjust the focus when a main object (for example, a bear) comes into an image (for example, the focus is on the background). Therefore, as illustrated in FIG. 18, when the main object occupies the screen and an AF is performed, since the focus position of the main object is not known, the search of the focus point in the whole scope is started.

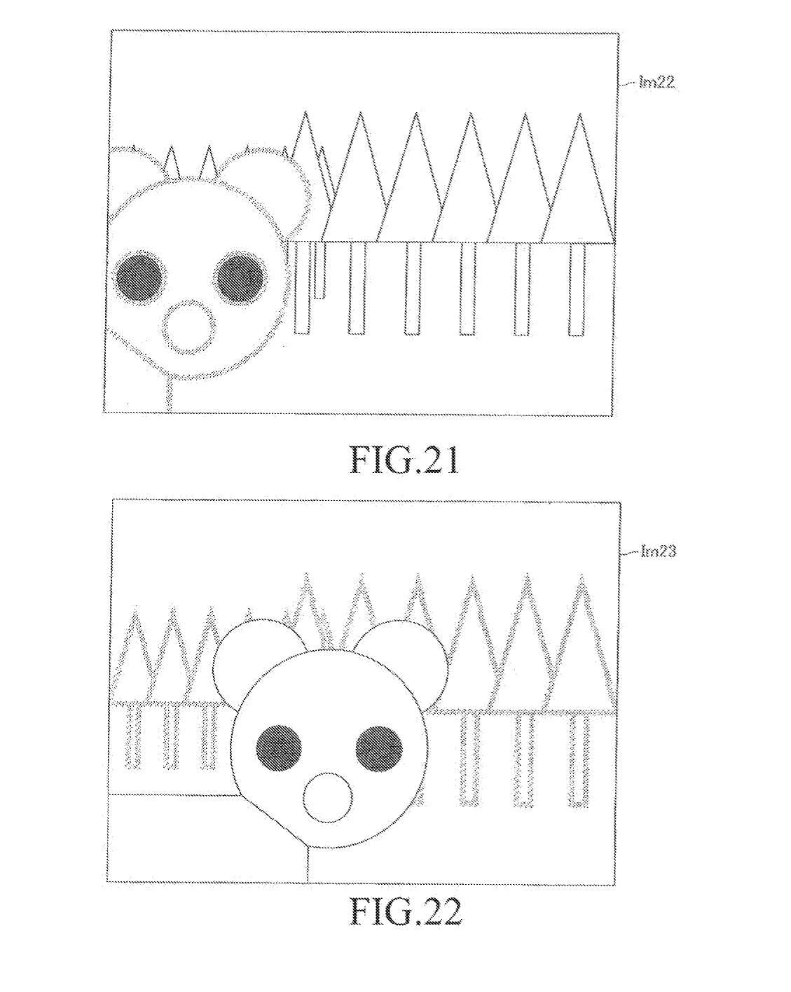

As illustrated in FIGS. 19 to 22, in case of using the imaging apparatus 10 according to the embodiment of the present invention, it is understood that the image changes in a series of the captured images Im20, Im21, Im22 (FIG. 21), and Im23. The image value degree becomes low since the object is not close to the center in the captured images Im20 and Im21, but since in the captured image Im22, the main object approximates to the center, the image value degree becomes medium, and since in the captured image Im23 (FIG. 22), the main object exists in the center, the image value degree becomes high. In case of using the imaging apparatus 10 according to the embodiment of the present invention, since the focus position is checked in advance when the image value degree is not high, the focus can be adjusted quickly when the main object occupies the screen.

In addition, according to the imaging apparatus 10 according to the embodiment of the present invention, power consumption can be suppressed. For example, when the lens driving is not performed, the power consumption is reduced by 7.5˜15% (depending on the configuration of the lens) on average in a measurement of an actual equipment compared with a case in which the lens driving is performed.

As described above, the imaging apparatus 10 according to the embodiment of the present invention includes an imaging unit that captures an image, an image value degree calculator that calculates an image value degree indicating a value of the image captured by the imaging unit, and an image controller that controls capturing by an imaging unit based on the image value degree calculated by the image value degree calculator. It is possible that capture control is performed based on the image value degree.

The embodiments of the present invention are described in detail with reference to the accompanied drawings, but the present invention is not limited thereto. It will be obvious by those skilled in the art that various changes in form and details may be made therein without departing from the spirit and scope of the present invention as defined by the appended claims and it is understood that the changes belong to the technical scope of the present invention.

What is claimed is:

1. An imaging apparatus comprising:
an imaging unit that captures an image;
an image value degree calculator that calculates an image value degree indicating a value of an image captured by the imaging unit; and
an image controller that controls capturing by the imaging unit depending on the image value degree calculated by the image value degree calculator.

2. The imaging apparatus according to claim 1, wherein the image value degree calculator calculates the image value degree by analyzing the image captured by the imaging unit.

3. The imaging apparatus according to claim 2, wherein the image value degree calculator calculates the image value degree according to an existing location of an object in the image.

4. The imaging apparatus according to claim 3, wherein the image value degree calculator calculates the image value degree according to a movement amount of the object in the image.

5. The imaging apparatus according to claim 1, further comprising:
an sound input unit that receives a sound,
wherein the image value degree calculator calculates the image value degree according to an analysis result of the sound received by the sound input unit.

6. The imaging apparatus according to claim 1, further comprising:
a detector that detects information indicating movement of the imaging apparatus as sensor information,
wherein the image value degree calculator calculates the image value degree by using the sensor information detected by the detector.

7. The imaging apparatus according to claim 1, further comprising:
a display control unit that controls a display unit so that a control result by the image controller is displayed on the display unit.

8. The imaging apparatus according to claim 1, wherein the image controller comprises at least one of a focus controller, an aperture controller, a zoom controller, an auxiliary light controller, and an appropriate AWB calculator.

9. A capturing method of an imaging apparatus, comprising:
capturing an image;
calculating an image value degree indicating a value of the image; and
controlling the capturing of the image according to the image value degree.

10. The capturing method according to claim 9, wherein the image value degree is calculated using an analysis result of the image captured by an imaging unit.

11. The capturing method according to claim 9, wherein the image value degree is calculated according to an existing location of an object in the image.

12. The capturing method according to claim 11, wherein the image value degree is calculated according to a movement amount of the object in the image.

13. The capturing method according to claim 9, wherein the image value degree is calculated according to an analysis result of a sound received by a sound input unit.

14. The capturing method according to claim 9, wherein the image value degree is calculated by using sensor information indicating movement of the image apparatus.

15. The capturing method according to claim 9, further comprising:
displaying a result of the capture control of the image on a display unit.

16. The capturing method according to claim 9, wherein the capture control of the image comprises at least one of focus control, aperture control, zoom control, auxiliary light control, and appropriate AWB calculation.
